(19) United States
(12) Patent Application Publication
(10) Pub. No.: US 2025/0368507 A1
(43) Pub. Date: Dec. 4, 2025

(54) STEAM-METHANE REFORMING IN HYDROGEN PRODUCTION

(71) Applicant: SAUDI ARABIAN OIL COMPANY, Dhahran (SA)

(72) Inventors: Eiman Hassan AL MUNIF, Dhahran (SA); Norah Abdullah ALJEABAN, Dhahran (SA); Damian Pablo SAN ROMAN ALERIGI, Dhahran (SA)

(73) Assignee: SAUDI ARABIAN OIL COMPANY, Dhahran (SA)

(21) Appl. No.: 18/731,183

(22) Filed: May 31, 2024

(51) Int. Cl. C01B 3/40; B01J 19/12

(52) U.S. Cl. CPC C01B 3/40; B01J 19/127; C01B 2203/0233; C01B 2203/0855; C01B 2203/1017; C01B 2203/1052; C01B 2203/1076; C01B 2203/1241; C01B 2203/1614; C01B 2203/1628

(57) ABSTRACT

Methane may be reformed through use of a solar reformer. Example methods of methane conversion through solar energy may include: supplying water and methane to a reaction chamber of a solar reformer unit; directing, using a solar reflector external to the reaction chamber, sunlight to one or more exterior solar absorbers of one or more solar absorbers; converting the sunlight into heat with the one or more solar absorbers; directing a portion of the heat converted by the one or more exterior solar absorbers to an interior of the reaction chamber using one or more light-porous pipes disposed within the reaction chamber; vaporizing at least a portion of the water to steam; and generating, within the reaction chamber, a reformate gas from the methane and the steam by a steam-methane reaction aided by one or more catalyst rods disposed within the reaction chamber.

### FIELD OF THE DISCLOSURE

The present disclosure relates generally to steam-methane reforming applications in hydrogen production.

### BACKGROUND OF THE DISCLOSURE

Hydrogen has a variety of industrial applications, including: ammonia production, methanol synthesis, petroleum refining, and as a fuel in fuel cells. However, conventional methods of producing hydrogen (e.g., such as natural gas steam reforming, partial oxidation, and electrolysis) have various drawbacks. For example, natural gas steam reforming and partial oxidation can emit significant amounts of carbon dioxide (CO₂) contributing to Greenhouse gas emissions. Electrolysis can be a cleaner method for producing hydrogen, but requires a large amount of electrical energy.

Steam-methane reforming is an alternative method for producing hydrogen. In the steam-methane reforming process, methane (CH₄) reacts with water (H₂O) to produce hydrogen gas (H₂) and carbon monoxide (CO). Subsequently, the carbon dioxide can be reacted with water to produce carbon dioxide (CO₂) and additional hydrogen gas.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A nonlimiting example method of the present disclosure may include: supplying water and methane to a reaction chamber of a solar reformer unit; directing, using a solar reflector external to the reaction chamber, sunlight to one or more exterior solar absorbers of one or more solar absorbers, wherein the one or more exterior solar absorbers are disposed on an exterior of the reaction chamber; converting the sunlight into heat with the one or more solar absorbers; directing a portion of the heat converted by the one or more exterior solar absorbers to an interior of the reaction chamber using one or more light-porous pipes disposed within the reaction chamber; vaporizing at least a portion of the water to steam using the portion of the heat within the reaction chamber; and generating, within the reaction chamber, a reformate gas from the methane and the steam by a steam-methane reaction aided by one or more catalyst rods disposed within the reaction chamber.

A nonlimiting example system of the present disclosure may include: a solar reformer unit configured to generate a reformate gas from water and methane via a steam-methane reaction, wherein the solar reformer unit comprises: a reaction chamber; a source of methane fluidly connected to the reaction chamber; a source of water fluidly connected to the reaction chamber; one or more solar absorbers disposed on an exterior surface of the reaction chamber, wherein the one or more solar absorbers are configured to convert sunlight into heat, wherein the one or more solar absorbers direct a portion of the heat to an interior of the reaction chamber, and wherein the heat converts at least a portion of the water to a quantity of steam, a solar reflector configured to direct sunlight to the one or more exterior solar absorbers; one or more catalyst rods disposed within the reaction chamber; one or more light-porous pipes disposed within the reaction chamber.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram showing a side-angle view of a solar reformer unit according to the present disclosure.

FIG. 2 is a diagram showing a top-down cross-section of a solar reformer unit according to the present disclosure.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to producing hydrogen gas via a catalyst aided steam-methane reaction. In various embodiments, the systems and/or methods described herein may feed water and methane to a steam-methane reaction. The steam-methane reaction may be heated by sunlight, specifically by reflection of sunlight to one or more solar absorbers, wherein the solar absorbers convert the sunlight to heat. Subsequently the water may be converted to steam and the combination of water and steam may undergo the steam-methane reaction in the presence of a catalyst. Such a catalyst may work to lower the activation energy of the steam-methane reaction. Systems and/or methods described herein may be more energy efficient than conventional methods, and may provide cost savings due to the use of solar heating thus reducing heating duty from other sources.

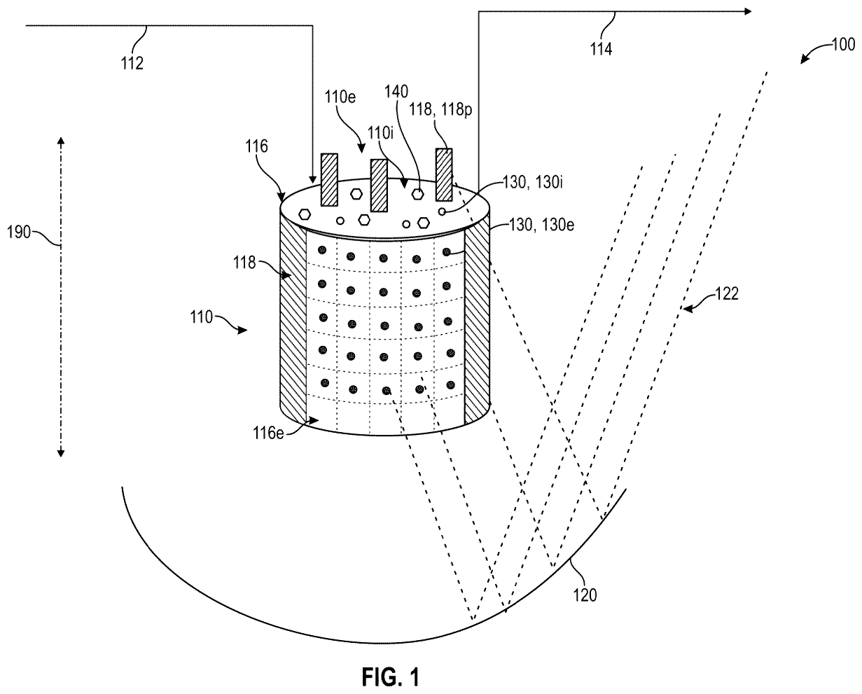

FIG. 1 depicts a side-angle view of a solar reformer unit 100 for production of hydrogen by steam-methane reaction according to the present disclosure. Reaction chamber 110 may be fluidly connected to one or more supply lines 112 for addition of water and/or methane. Reaction chamber 110 may be fluidly connected to one or more output lines 114 for removal of reformate gas (including hydrogen and/or other byproducts). Reaction chamber 110 may have a solar reflector 120 for directing sunlight 122 toward one or more solar absorbers 130, including one or more exterior solar absorbers 130e disposed along the exterior surface 116e of the wall 116 of reaction chamber 110 as well as one or more interior solar absorbers 130i within the interior 110i of the reaction chamber 110. Sunlight 122 may be directed to the interior 110i of the reaction chamber through a light-porous zone 118 of reaction chamber 110, wherein the light-porous zone 118 may be a component of or otherwise penetrate through wall 116. Light-porous zone 118 may include any suitable means of directing sunlight into the interior 110i of the reaction chamber 110, including for example optionally through one or more light-porous pipes 118p. One or more light-porous pipes 118p may extend from interior 110i to the exterior 110e of reaction chamber 110. One or more light-porous pipes 118p may be arranged vertically along the major axis (as shown by arrow 190) of reaction chamber 110. Light-porous zone 118 (including, e.g., one or more light-porous pipes 118p) may bring sunlight 122 to the interior 110i of reaction chamber 110 for further interaction with compounds and materials therein, including with one or more interior solar absorbers 130i. The one or more solar absorbers 130 (including one or more interior solar absorbers 130i and/or one or more exterior solar absorbers 130e) may convert sunlight 122 to heat, thus heating and/or vaporizing water within the reaction chamber 110. Water (e.g., steam) and methane may react with one or more catalyst rods 140 disposed within reaction chamber 110 to generate reformate gas (including hydrogen). One or more catalyst rods 140 may be arranged vertically along the major axis (as shown by arrow 190) of reaction chamber 110.

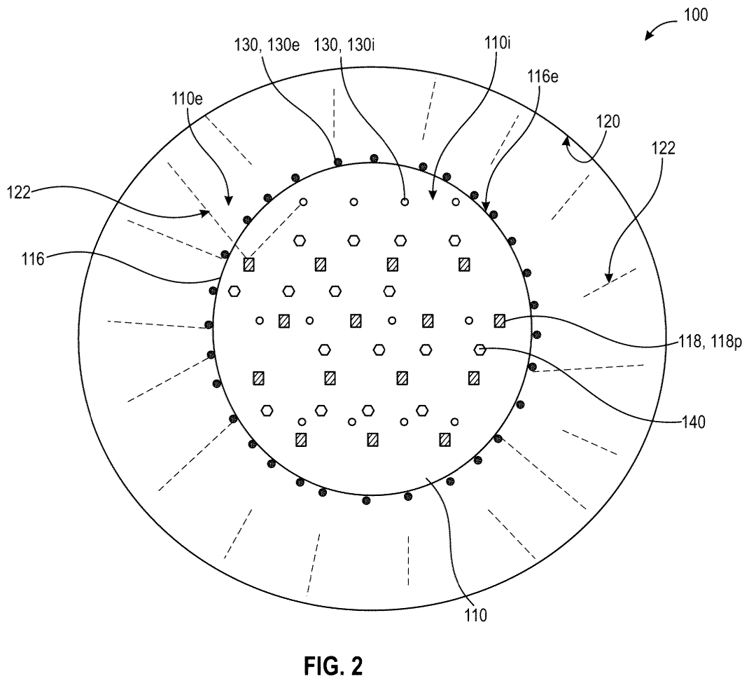

FIG. 2 depicts a top-down cross-section of a solar reformer unit 100. Continuing reference to FIG. 1, reaction chamber 110 may have a solar reflector 120 for directing sunlight 122 toward one or more solar absorbers 130, including one or more exterior solar absorbers 130e disposed along the exterior surface 116e of the wall 116 of reaction chamber 110 as well as one or more interior solar absorbers 130i within the interior 110i of the reaction chamber 110. Sunlight 122 may be directed to the interior 110i through light-porous zone 118, including optionally through one or more light-porous pipes 118p. One or more catalyst rods 140 may furthermore may be located within reaction chamber 110. As shown in FIG. 2, one or more interior solar absorbers 110i, one or more catalyst rods 140, and, optionally, one or more light-porous pipes 118p (if included), may all be arranged in a matrix, as viewed in the cross-section shown in FIG. 2.

Solar reflectors of the present disclosure may comprise any suitable material for directing sunlight to a desired location of a solar reformer unit. Examples of solar reflector materials of the present disclosure may include, but are not limited to, glass, a polymer, a metal, a composite thereof, the like, or any suitable combination of the foregoing. Solar reflectors of the present disclosure may have any suitable shape for directing sunlight to desired region(s) of a solar reformer unit. Example shapes may include flat, parabolic, curved, the like, or any combination thereof. Some shapes such as, for example, parabolic, may allow for use of a parabolic solar reflector that may concentrate sunlight to desired region(s) (e.g., at one or more solar absorbers, at one or more light-porous pipes, the like).

Reaction chambers of the present disclosure (e.g., reaction chamber 110) may be of any suitable material for use in systems and/or methods of the present disclosure for a steam-methane reaction. As discussed above, portions of the reaction chamber may be made of light-porous material (e.g., light-porous zone 118 and/or one or more light-porous pipes 118p). Such light-porous materials may include any suitable materials that permit transmission of light (e.g., sunlight 122) to the interior (e.g., interior 110i) of a reaction chamber. Light-porous materials may include, translucent materials, transparent materials, porous materials, the like, or any combination thereof. Examples of light-porous materials may include, but are not limited to, glass, quartz, a ceramic, acrylic, a polymer, the like, or any combination thereof.

Various components of solar reformer units may be oriented vertically along a major axis of a reaction chamber. “Vertically along a major axis of a reaction chamber,” and grammatical variations thereof, as used herein, may refer to wherein a component (e.g., a light-porous pipe, a catalyst rod, the like, or any combination thereof) may be generally oriented along a length of a reaction chamber. Whereby a reaction chamber may be generally cylindrical, a “major axis” may be defined as extending between ends of the reaction chamber having a circular cross-section. As a nonlimiting example, FIG. 1 shows a major axis of reaction chamber 110 as arrow 190. As a further nonlimiting example, in FIG. 2, a major axis of reaction chamber 110 would extend directly into and/or out of the plane of the cross-section shown.

Water for use in systems and/or methods of the present disclosure may be from any suitable source, including, but not limited to, a water well, a water treatment system, the like, or any combination thereof. “Water,” as used herein for use in systems and/or methods of the present disclosure may comprise any aqueous fluid including, but not limited to, for example, brine, seawater, waste water, brine from desalination, produced water, formation water, the like, or any combination thereof. The optional water treatment system, if included, may serve to pre-treat water used in the steam-methane reaction so as to remove undesired impurities that may mitigate catalyst activity during the steam-methane reaction. Water treatment may be employed to remove the contaminants of water used in the steam-methane reaction via one or more water treatment techniques, such as, but not limited to, oil-water separation, filtration (e.g., media filters, cartridge filters, and/or bag filters), coagulation and/or flocculation, desalination, biological treatment, advanced oxidation, adsorption, ion exchange, thermal treatments, membrane filtration, chemical precipitation, a combination thereof, and/or the like.

Water within a reaction chamber (e.g., reaction chamber 110) may be heated and/or vaporized to form steam by one or more solar absorbers (e.g., one or more solar absorbers 130), including one or more exterior solar absorbers (e.g., one or more exterior solar absorbers 130c) and/or one or more interior solar absorbers (e.g., one or more interior solar absorbers 130i). Solar absorbers used in the present disclosure may function to convert photonic energy of sunlight into heat. Solar absorbers of the present disclosure may convert a majority of photonic energy within received sunlight to heat, including greater than 50%, or greater than 75%, or greater than 80% or greater than 90%, or greater than 95%, or 50% to 99.99%, or 75% to 99.99%, or 90% to 99.99%, or 95% to 99.99% conversion of photonic energy to heat. As a nonlimiting example, a 1 square meter area first solar absorber may receive a quantity of sunlight having a power of 1300 watts per square meter, thus resulting in 78 kJ of received photonic energy (e.g., a first photonic energy) per minute; thus, if 90% or greater of the photonic energy received by the first solar absorber is converted to heat, then 70.2 kJ or greater are generated.

The one or more solar absorbers may comprise metallic absorbers, semiconductors, ceramics, polymers, carbon-based materials, selective absorbers, the like, or any combination thereof. The one or more solar absorbers may be attached or otherwise affixed to a reaction chamber through the use of an adhesive or other suitable fastener means. Examples of suitable adhesives may include, but are not limited to, ceramic adhesive, metallic adhesive, epoxy resin, silicone adhesive, acrylic adhesive, polyurethane adhesive, conductive adhesive, pressure-sensitive adhesive (PSA), the like, or any combination thereof. The one or more solar absorbers (including the one or more exterior solar absorbers and/or the one or more interior solar absorbers) may be arranged in a matrix. A “matrix,” and grammatical variations thereof, as used herein refers to components (e.g., one or more solar absorbers) arranged in an array with a repeating pattern, such as, for example, a grid. The array of the one or more solar absorbers may thus be modular; due to the modularity and attachment or otherwise affixing by adhesive or other such means, in some embodiments, the one or more solar absorbers may be removable. A portion or all of the one or more solar absorbers may be removed and/or replaced, facilitating case of maintenance and potential upgradability of the one or more solar absorbers.

In some embodiments water may be heated and/or vaporized by a supplemental heat source, in addition to the one more solar absorbers. Examples of supplemental heat sources may include, but are not limited to, fire-tube boilers, water-tube boilers, electric steam boilers, once-through steam generators, heat recovery steam generators, waste heat boilers, package boilers, fluidized bed boilers, biomass boilers, thermal oil heaters, the like, or any combination thereof.

Steam, whether heated and/or vaporized by the one or more solar absorbers, by a supplemental heat source, or a combination thereof may have a temperature ranging from greater than or equal to about 120° C. to less than or equal to about 600° C., or a pressure ranging from greater than or equal to about 14 bar to less than or equal to about 40 bar.

Methane supplied to a reaction chamber may be derived from any suitable source including natural gas. Such natural gas may undergo any suitable preprocessing to separate methane therein from various hydrocarbons other than methane (e.g., ethane, propane, butane), and/or various impurities (e.g., water vapor, carbon dioxide, hydrogen sulfide, nitrogen, the like). Preprocessing of natural gas may include, but is not limited to, for example, gas dehydration, acid gas removal, natural gas liquids recovery, nitrogen removal, mercury removal, desulphurization, the like, or any combination thereof. Methane supplied to the solar reformer may generally have a methane purity level of about 70 mol % or greater, or about 80 mol % or greater, or about 90 mol %, or greater than about 95 mol %, or about 50 mol % to about 99.99 mol %, or about 75 mol % to about 99.99 mol %, or about 90 mol % to about 99.99 mol %, or about 95 mol % to about 99.99 mol % CH₄.

Solar reformer units of the present disclosure may facilitate a steam-methane reforming reaction to produce a reformate gas; which may include a syngas, excess water, and/or excess catalyst. While FIGS. 1 and 2 depict the use of a single solar reformer unit 100, the architecture of systems and/or methods of the present disclosure is not so limited. For example, embodiments that include a plurality of solar reformer units (e.g., connected in parallel and/or in series) are also envisaged. Solar reformer units may include any suitable conformation of one or more catalyst rods or other such catalyst vehicle therein. While traversing catalyst rods (e.g., one or more catalyst rods 140), water and methane can undergo a steam-methane reforming reaction characterized by Equation 1 below.

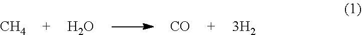

For instance, the steam-methane reforming reaction is an endothermic reaction that takes place within a reaction chamber of a solar reformer unit (e.g., reaction chamber 110 of solar reformer unit 100) between the methane and the water (e.g., methane and water from supply line 112) to form syngas (e.g., comprising CO+3H₂). In various embodiments, the steam-methane reforming reaction can take place at a high temperature and low pressure within a solar reformer unit. Example operating conditions can include a temperature between about 600° C. and 1000° C.; and a pressure between about 150 psi and about 350 psi.

In various embodiments, catalyst rods (e.g., one or more catalyst rods 140) of the present disclosure can be filled with a catalyst, a support compound, and/or a promoter compound to facilitate the steam-methane reforming reaction. Catalyst compounds utilized in steam-methane reactions may include, but are not limited to, nickel-based catalyst, noble metal-based catalysts, cobalt-based catalysts, and copper-based catalysts. Catalyst compounds may be present within catalyst rods of the present disclosure in any suitable conformation including catalyst tubes, catalyst pellets, catalyst clusters, the like, or any combination thereof.

Reformate gas (e.g., within output line 114) produced by solar reformer units of the present disclosure may comprise a syngas. Example reformate gas compositions of the present disclosure may comprise about 1 volume percent (vol %) to about 7 vol % methane, about 25 vol % to about 75 vol % hydrogen, about 5 vol % to about 20 vol % carbon dioxide; about 5 vol % to about 20 vol % carbon monoxide, about 1 vol % to about 20 vol % water, and about 0.05 vol % to about 1 vol % catalyst, by volume of the reformate gas.

Reformate gas can be subsequently supplied to further units for processing, including, for example, to a shift reactor to facilitate an exothermic water-gas shift reaction. Such a water-gas shift reaction can increase the yield of hydrogen produced by methods and/or systems of the present disclosure by converting the carbon monoxide of the reformate gas into carbon dioxide in accordance with Equation 2 below.

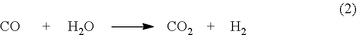

In accordance with Equation 2, excess water present in the reformate gas (e.g., an excess resulting from a high steam to carbon ratio in a solar reformer unit) can be utilized to convert the carbon monoxide of the reformate gas into carbon dioxide and additional hydrogen. One of ordinary skill in the art will be able to appropriately select and implement a suitable shift reactor and/or associated water-gas shift reaction methods for use in accordance with the present disclosure.

It should be noted that additional nonlimiting components may be used in systems and/or methods suitable for hydrogen production according to the present disclosure, including for steam-methane reaction and associated processes. Such additional components will be familiar to one having ordinary skill in the art and include, but are not limited to, supply hoppers, valves, condensers, adapters, joints, gauges, sensors, compressors, pressure controllers, pressure sensors, flow rate controllers, flow rate sensors, temperature sensors, heat exchangers, the like, or any combination thereof.

### Additional Embodiments

The present disclosure is also directed to the following exemplary embodiments, which can be practiced in any combination thereof:

Embodiment 1. A method comprising: supplying water and methane to a reaction chamber of a solar reformer unit; directing, using a solar reflector external to the reaction chamber, sunlight to one or more exterior solar absorbers of one or more solar absorbers, wherein the one or more exterior solar absorbers are disposed on an exterior surface of the reaction chamber; converting the sunlight into heat with the one or more solar absorbers; directing a portion of the heat converted by the one or more exterior solar absorbers to an interior of the reaction chamber using one or more light-porous pipes disposed within the reaction chamber; vaporizing at least a portion of the water to steam using the portion of the heat within the reaction chamber; and generating, within the reaction chamber, a reformate gas from the methane and the steam by a steam-methane reaction aided by one or more catalyst rods disposed within the reaction chamber.

Embodiment 2. The method of Embodiment 1, wherein a first solar absorber of the one or more solar absorbers is configured to receive a first quantity of the sunlight, wherein the first quantity of the sunlight has a first photonic energy, and wherein the first solar absorber is capable of converting 90% or greater of the first photonic energy to heat.

Embodiment 3. The method of Embodiments 1 or 2, wherein the one or more exterior solar absorbers are disposed on the exterior surface of the reaction chamber through an adhesive material.

Embodiment 4. The method of Embodiment 3, wherein the adhesive material comprises a ceramic adhesive, a metallic adhesive, an epoxy resin, a silicone adhesive, an acrylic adhesive, a polyurethane adhesive, a conductive adhesive, a pressure-sensitive adhesive (PSA), or any combination thereof.

Embodiment 5. The method of any one of Embodiments 1-4, wherein reaction conditions within the reaction chamber include a temperature between 600° C. and 1000° C. and a pressure between 40 psi and 350 psi.

Embodiment 6. The method of any one of Embodiments 1-5, wherein the one or more catalyst rods comprise a nickel-based catalyst, a noble metal-based catalyst, a cobalt-based catalyst, a copper-based catalyst, or any combination thereof.

Embodiment 7. The method of any one of Embodiments 1-6, wherein the solar reflector comprises a parabolic solar reflector, and wherein the parabolic solar reflector is configured to concentrate the sunlight to the one or more solar absorbers.

Embodiment 8. The method of any one of Embodiments 1-7, wherein the one or more solar absorbers comprises a metallic absorber, a semiconductor, a ceramic, a polymer, a carbon-based material, a selective absorber, or any combination thereof.

Embodiment 9. The method of any one of Embodiments 1-8, wherein the one or more light-porous pipes comprise glass, quartz, a ceramic, acrylic, a polymer, or any combination thereof.

Embodiment 10. The method of any one of Embodiments 1-9, wherein the one or more solar absorbers further comprise one or more interior solar absorbers, wherein the one or more interior solar absorbers are arranged vertically along a major axis of the reaction chamber.

Embodiment 11. The method of any one of Embodiments 1-10, wherein the one or more light-porous pipes, the one or more solar absorbers, and the one or more catalyst rods are arranged vertically along a major axis of the reaction chamber, and wherein the one or more light-porous pipes, the one or more solar absorbers, and the one or more catalyst rods are arranged in a matrix.

Embodiment 12. The method of any one of Embodiments 1-11, further comprising: receiving, using a first solar absorber of the one or more solar absorbers a first quantity of the sunlight, wherein the first quantity of the sunlight has a first photonic energy; and converting, using the first solar absorber, 90% or greater of the first photonic energy to heat.

Embodiment 13. A system comprising: a solar reformer unit configured to generate a reformate gas from water and methane via a steam-methane reaction, wherein the solar reformer unit comprises: a reaction chamber; a source of methane fluidly connected to the reaction chamber; a source of water fluidly connected to the reaction chamber; one or more solar absorbers disposed on an exterior surface of the reaction chamber, wherein the one or more solar absorbers are configured to convert sunlight into heat, wherein the one or more solar absorbers direct a portion of the heat to an interior of the reaction chamber, and wherein the heat converts at least a portion of the water to a quantity of steam; a solar reflector configured to direct sunlight to the one or more exterior solar absorbers; one or more catalyst rods disposed within the reaction chamber; and one or more light-porous pipes disposed within the reaction chamber.

Embodiment 14. The system of Embodiment 13, wherein a first solar absorber of the one or more solar absorbers is configured to receive a first quantity of the sunlight, wherein the first quantity of the sunlight has a first photonic energy, and wherein the first solar absorber is capable of converting 90% or greater of the first photonic energy to heat.

Embodiment 15. The system of Embodiments 13 or 14, wherein the one or more exterior solar absorbers are disposed on the exterior surface of the reaction chamber through an adhesive material.

Embodiment 16. The system of Embodiment 15, wherein the adhesive material comprises a ceramic adhesive, a metallic adhesive, an epoxy resin, a silicone adhesive, an acrylic adhesive, a polyurethane adhesive, a conductive adhesive, a pressure-sensitive adhesive (PSA), or any combination thereof.

Embodiment 17. The system of any one of Embodiments 13-16, wherein reaction conditions within the reaction chamber include a temperature between 600° C. and 1000° C. and a pressure between 40 psi and 350 psi.

Embodiment 18. The system of any one of Embodiments 13-17, wherein the one or more catalyst rods comprise a nickel-based catalyst, a noble metal-based catalyst, a cobalt-based catalyst, a copper-based catalyst, or any combination thereof.

Embodiment 19. The system of any one of Embodiments 13-18, wherein the solar reflector comprises a parabolic solar reflector, and wherein the parabolic solar reflector is configured to concentrate the sunlight to the one or more solar absorbers.

Embodiment 20. The system of any one of Embodiments 13-19, wherein the one or more solar absorbers comprises a metallic absorber, a semiconductor, a ceramic, a polymer, a carbon-based material, a selective absorber, or any combination thereof.

Embodiment 21. The system of any one of Embodiments 13-20, wherein the one or more light-porous pipes comprise glass, quartz, a ceramic, acrylic, a polymer, or any combination thereof.

Embodiment 22. The system of any one of Embodiments 13-21, wherein the one or more solar absorbers further comprise one or more interior solar absorbers, wherein the one or more interior solar absorbers are arranged vertically along a major axis of the reaction chamber.

Embodiment 23. The system of any one of Embodiments 13-22, wherein the one or more light-porous pipes, the one or more solar absorbers, and the one or more catalyst rods are arranged vertically along a major axis of the reaction chamber, and wherein the one or more light-porous pipes, the one or more solar absorbers, and the one or more catalyst rods are arranged in a matrix.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
supplying water and methane to a reaction chamber of a solar reformer unit;
directing, using a solar reflector external to the reaction chamber, sunlight to one or more exterior solar absorbers of one or more solar absorbers, wherein the one or more exterior solar absorbers are disposed on an exterior surface of the reaction chamber;
converting the sunlight into heat with the one or more solar absorbers;
directing a portion of the heat converted by the one or more exterior solar absorbers to an interior of the reaction chamber using one or more light-porous pipes disposed within the reaction chamber;
vaporizing at least a portion of the water to steam using the portion of the heat within the reaction chamber; and
generating, within the reaction chamber, a reformate gas from the methane and the steam by a steam-methane reaction aided by one or more catalyst rods disposed within the reaction chamber.

2. The method of claim 1, wherein a first solar absorber of the one or more solar absorbers is configured to receive a first quantity of the sunlight, wherein the first quantity of the sunlight has a first photonic energy, and wherein the first solar absorber is capable of converting 90% or greater of the first photonic energy to heat.

3. The method of claim 1, wherein the one or more exterior solar absorbers are disposed on the exterior surface of the reaction chamber through an adhesive material.

4. The method of claim 3, wherein the adhesive material comprises a ceramic adhesive, a metallic adhesive, an epoxy resin, a silicone adhesive, an acrylic adhesive, a polyurethane adhesive, a conductive adhesive, a pressure-sensitive adhesive (PSA), or any combination thereof.

5. The method of claim 1, wherein reaction conditions within the reaction chamber include a temperature between 600° C. and 1000° C. and a pressure between 40 psi and 350 psi.

6. The method of claim 1, wherein the one or more catalyst rods comprise a nickel-based catalyst, a noble metal-based catalyst, a cobalt-based catalyst, a copper-based catalyst, or any combination thereof.

7. The method of claim 1, wherein the solar reflector comprises a parabolic solar reflector, and wherein the parabolic solar reflector is configured to concentrate the sunlight to the one or more solar absorbers.

8. The system of method 1, wherein the one or more solar absorbers comprises a metallic absorber, a semiconductor, a ceramic, a polymer, a carbon-based material, a selective absorber, or any combination thereof.

9. The method of claim 1, wherein the one or more solar absorbers further comprise one or more interior solar absorbers, wherein the one or more interior solar absorbers are arranged vertically along a major axis of the reaction chamber.

10. The method of claim 1, wherein the one or more light-porous pipes, the one or more solar absorbers, and the one or more catalyst rods are arranged vertically along a major axis of the reaction chamber, and wherein the one or more light-porous pipes, the one or more solar absorbers, and the one or more catalyst rods are arranged in a matrix.

11. The method of claim 1, further comprising:
receiving, using a first solar absorber of the one or more solar absorbers a first quantity of the sunlight, wherein the first quantity of the sunlight has a first photonic energy; and
converting, using the first solar absorber, 90% or greater of the first photonic energy to heat.

12. A system comprising:
a solar reformer unit configured to generate a reformate gas from water and methane via a steam-methane reaction, wherein the solar reformer unit comprises:
a reaction chamber;
a source of methane fluidly connected to the reaction chamber;
a source of water fluidly connected to the reaction chamber;
one or more solar absorbers disposed on an exterior surface of the reaction chamber,
wherein the one or more solar absorbers are configured to convert sunlight into heat,
wherein the one or more solar absorbers direct a portion of the heat to an interior of the reaction chamber, and wherein the heat converts at least a portion of the water to a quantity of steam;
a solar reflector configured to direct sunlight to the one or more exterior solar absorbers;
one or more catalyst rods disposed within the reaction chamber; and
one or more light-porous pipes disposed within the reaction chamber.

13. The system of claim 12, wherein a first solar absorber of the one or more solar absorbers is configured to receive a first quantity of the sunlight, wherein the first quantity of the sunlight has a first photonic energy, and wherein the first solar absorber is capable of converting 90% or greater of the first photonic energy to heat.

14. The system of claim 12, wherein reaction conditions within the reaction chamber include a temperature between 600° C. and 1000° C. and a pressure between 40 psi and 350 psi.

15. The system of claim 12, wherein the one or more catalyst rods comprise a nickel-based catalyst, a noble metal-based catalyst, a cobalt-based catalyst, a copper-based catalyst, or any combination thereof.

16. The system of claim 12, wherein the solar reflector comprises a parabolic solar reflector, and wherein the parabolic solar reflector is configured to concentrate the sunlight to the one or more solar absorbers.

17. The system of claim 12, wherein the one or more solar absorbers comprises a metallic absorber, a semiconductor, a ceramic, a polymer, a carbon-based material, a selective absorber, or any combination thereof.

18. The system of claim 12, wherein the one or more light-porous pipes comprise glass, quartz, a ceramic, acrylic, a polymer, or any combination thereof.

19. The system of claim 12, wherein the one or more solar absorbers further comprise one or more interior solar absorbers, wherein the one or more interior solar absorbers are arranged vertically along a major axis of the reaction chamber.

20. The system of claim 12, wherein the one or more light-porous pipes, the one or more solar absorbers, and the one or more catalyst rods are arranged vertically along a major axis of the reaction chamber, and wherein the one or more light-porous pipes, the one or more solar absorbers, and the one or more catalyst rods are arranged in a matrix.
